(19) United States
(12) Patent Application Publication
(10) Pub. No.: US 2007/0168869 A1
(43) Pub. Date: Jul. 19, 2007

(54) METHOD FOR UPDATING A CALENDAR AND COMPUTER PROGRAM ELEMENT THEREFOR

(75) Inventor: Suyog Vaidya, Malmo (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: SONY ERICSSON MOBILE COMMUNICATIONS AB, Lund (SE)

(21) Appl. No.: 11/306,870

(22) Filed: Jan. 13, 2006

(51) Int. Cl. G06F 9/00

(52) U.S. Cl. 715/733; 715/764; 715/963

(57) ABSTRACT

The invention relates to a method for updating a calendar in a device like a mobile telephone and a computer program element configured to perform the update. The method comprises: connecting the device to a calendar database containing a set of calendar items; synchronizing the calendar in the device with said set of calendar items, so that the calendar in the device is updated to contain said set of calendar items, e.g. pertaining to a local calendar reflecting public holidays and other useful information.

### DESCRIPTION

1. Field of the invention

The present invention relates to a method for updating a calendar in a device like a mobile telephone and a computer program element configured to perform the update. The invention enables a public holiday/specific event utility for the calendar application in the device.

2. State of the art

Portable devices such as mobile telephones and personal digital assistants and the like often incorporate calendars, i.e. program modules for displaying dates and times and scheduling reminders and tasks and other calendar items. Such devices may be connected to external systems and devices for synchronizing with other calendars in order to facilitate entry of items. The calendar is of course configured to display the name of the days, so that the user knows the dates of working days and weekends.

A specific problem, e.g. when the user is traveling, is that local holidays may fall on what the user believes to be working days. Then, shops may be closed but there is no indication in the device's calendar.

### SUMMARY OF THE INVENTION

An object of the present invention is to update or adapt a calendar in a device with a set of calendar items, e.g. pertaining to a local calendar reflecting public holidays and other useful information.

In a first aspect the invention provides a method for updating a calendar in a device, comprising:

connecting the device to a calendar database containing a set of calendar items;

synchronizing the calendar in the device with said set of calendar items, so that the calendar in the device is updated to contain said set of calendar items.

In one embodiment, the device is customized with the set of calendar items by installing a file system during programming of the device before sale.

In another embodiment, the device is customized with the set of calendar items by installing a file system downloaded from a computer.

The computer may be a server contacted over a telecommunication system.

Said set of calendar items maybe updated by means of a message (SMS/MMS).

The computer may be a local computer connected to the device.

The set of calendar items may be installed in the local computer by contacting a server over a telecommunication system.

The set of calendar items may be installed in the local computer by means of a computer readable medium delivered together with the device.

In a second aspect the invention provides a computer program element comprising: a set of calendar items, and configured to cooperate with a calendar in a device in order to synchronize a calendar in the device with said set of calendar items, so that the calendar in the device is updated to contain said set of calendar items.

The computer program element may be stored on a computer readable medium, and configured to be copied and installed in the device.

The computer program element may be stored in a server connectable to the device, and configured to be copied and installed in the device.

### BRIEF DESCRIPTION OF THE DRAWINGS

The invention will be described below with reference to the accompanying drawings, in which:

FIG. 1 is a schematic view of a device connectable to a computer and/or a server for performing the method according to the invention, and

FIG. 2 is a schematic view of an example of a displayed image containing a calendar item.

### DETAILED DESCRIPTION OF PREFERRED EMBODIMENTS

The invention will be described in the context of mobile telephones and similar devices, such as communicators and smart phones. The specification will focus on functions relevant to the present invention, while other functions, such as the operation of radio interfaces, color displays, user interfaces etc may be conventional.

The term File System in the context of this specification, implies a software programmable entity which is customized for specific region/country. The File System may hold, among other settings, the language related settings of that region/country. It also contains all the standard icons, pictures, sounds, ring tones, etc which are provided in the device. Thus, it constitutes region specific customizable data.

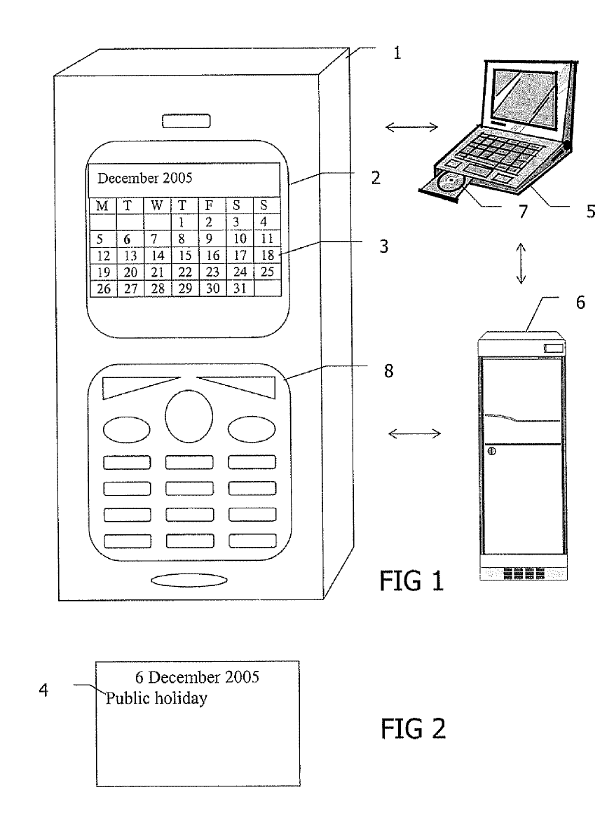

FIG. 1 is a schematic representation of a device, such as a mobile telephone, applicable in the present invention. The device 1 comprises a display 2 and a keypad 8. The keypad may be used for controlling operations as conventional, such as dialing and other functions. Data may be entered including numbers, letters and other characters for forming messages and entries in a calendar.

The display 2 is configured to show information relating to operations of the device 1. FIG. 1 shows a typical calendar with the name of month, number of year and days arranged in rows for separate weeks. Other views are possible and may be selected by the user to show only one week or one day. A specific view may be preselected, or the user may switch between different desired views.

Typically, a day containing an entry is highlighted in one way or other such as shown in bold type at day 6. The user may select and open any day to view the respective items.

FIG. 2 shows an example of one calendar item 4 as shown when the user has selected and opened the day 6 Dec. 2005. In this case, the item is “Public holiday”. Public holidays may also be marked with special colors, typically red for non-working days.

As mentioned in the introduction, a special problem is to adapt the calendar to local circumstances, e.g. public holidays, and incorporate such items and other useful information in the calendar of the device 1 in a user-friendly manner. Thus, the invention provides a method for updating a calendar in a device so that the calendar reflects working and non-working days and other useful information.

A calendar item 4, such as shown in FIG. 2, is entered preferably by synchronizing the calendar of the device 1 with a set of calendar items contained in a database. By synchronizing the database with the calendar in the device, the calendar item 4 is entered automatically without any user action except requesting the synchronization. In this specification, the term “synchronization” refers to any method of programming the calendar in a device such that calendar items are correctly entered with a suitable text string on the specific correct time and date.

In one embodiment, the device 1 is programmed with a set of calendar items. This may be performed by the manufacturer or a retailer even before the device is sold to a customer. Suitably, the set of calendar items is included in a file system of a particular region, such as a country or continent.

In another embodiment, the device 1 is prompted to be programmed by the user who retrieves the set of calendar items through a telecommunication system. The set of calendar items may be released on the Internet. The user contacts a web server 6, either directly with the device 1 or with a local computer 5. Then, the set of calendar items is downloaded to the device 1 by means of a web browser of the device 1 or by means of a web browser of the computer 5, which in turn can communicate with the device 1. The local computer 5 may be connected to the device 1 via a USB cable, an infrared interface or short range radio interface, e.g. Bluetooth®.

A service provider such as a telecommunications operator or a mobile telephone manufacturer may also offer calendar updates through other means of telecommunication, such as SMS, Short Message Service, or MMS, Multi Media Service, messages. Thus, a user may find a calendar update on a website, either through his mobile device 1 or his computer 5, and request for such update to be sent to the device in a message. An update may also be executed as an SMS or MMS push operation from the service provider to the device based on the subscription level of the user. Then, the update shall take place on confirmation from the user. The payment method may be conventional and does not form part of the present invention.

Suitably, the set of calendar items are arranged in the server 6 in the form of modules for different regions, which may be downloaded separately as desired by the user. National operators and manufacturers can provide their own versions of calendar items and make them available at their national web servers. Other organizations such as churches and sports organizations may provide calendar items of interest for people with specific interests. Also, a general global set of calendar items may be available.

In another embodiment, the set of calendar items is supplied on a computer readable medium, such as a CD 7, or the like. The CD may be delivered together with the device 1 when purchased. Other readable media may be connectable directly to the device 1, if the device is provided with a memory card reader or the like. In this case too, the set of calendar items may be arranged so that the user can select a set suitable for the occasion. In this case, the user may perform an update any time without having to establish a connection over a telecommunication system.

The invention may be implemented by suitable combinations of software and hardware, as is known in the art. Changes may be made in details without exceeding the scope of the invention. The scope of the invention is only limited by the attached claims.

What is claimed is:

1. A method for updating a calendar in a device, comprising:
connecting the device to a calendar database containing a set of calendar items;
synchronizing the calendar in the device with said set of calendar items, so that the calendar in the device is updated to contain said set of calendar items.

2. A method according to claim 1, wherein the device is customized with the set of calendar items by installing a file system during programming of the device before sale.

3. A method according to claim 1, wherein the device is customized with the set of calendar items by installing a file system downloaded from a computer.

4. A method according to claim 3, wherein the computer is a server contacted over a telecommunication system.

5. A method according to claim 4, wherein said set of calendar items is updated by means of a message (SMS/MMS).

6. A method according to claim 3, wherein the computer is a local computer connected to the device.

7. A method according to claim 6, wherein the set of calendar items is installed in the local computer by contacting a server over a telecommunication system.

8. A method according to claim 6, wherein the set of calendar items is installed in the local computer by means of a computer readable medium delivered together with the device.

9. A computer program element comprising:
a set of calendar items, and configured to cooperate with a calendar in a device in order to synchronize a calendar in the device with said set of calendar items, so that the calendar in the device is updated to contain said set of calendar items.

10. A computer program element according to claim 9, stored on a computer readable medium, and configured to be copied and installed in the device.

11. A computer program element according to claim 9, stored in a server connectable to the device, and configured to be copied and installed in the device.
